(19) United States
(12) Patent Application Publication
(10) Pub. No.: US 2025/0383991 A1
(43) Pub. Date: Dec. 18, 2025

(54) FOLDING MANAGEMENT FOR TWO-PASS PROGRAMMING OF MEMORY DEVICES

(71) Applicant: MICRON TECHNOLOGY, INC., Boise, ID (US)

(72) Inventors: Tom V. Geukens, Longmont, CO (US); Amit Bhardwaj, Hyderabad (IN); Byron D. Harris, Mead, CO (US)

(21) Appl. No.: 19/236,532

(22) Filed: Jun. 12, 2025

Related U.S. Application Data
(60) Provisional application No. 63/659,948, filed on Jun. 14, 2024.

(51) Int. Cl. G06F 12/0802

(52) U.S. Cl. CPC G06F 12/0802; G06F 2212/60

(57) ABSTRACT

A memory system includes a volatile memory device; a non-volatile memory device; and a processing device, operatively coupled with the volatile memory device and the non-volatile memory device, to perform operations including retrieving data stored in a set of source management units on the non-volatile memory device; storing the data in a set of cache management units on the volatile memory device in a predefined order of the set of cache management units; and sending the data in the predefined order to a set of destination management units on the non-volatile memory device.

### RELATED APPLICATIONS

This application claims the benefit of U.S. Provisional Patent Application No. 63/659,948, filed Jun. 14, 2024, the entire contents of which are incorporated by reference herein.

### TECHNICAL FIELD

Embodiments of the disclosure relate generally to memory sub-systems, and more specifically, relate to folding management for two-pass programming of memory devices.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example computing system that includes a memory sub-system in accordance with some embodiments of the present disclosure.

FIGS. 2 and 3 illustrate block diagrams of systems that perform folding management for two-pass programming operations in accordance with some embodiments of the present disclosure.

FIGS. 4 and 5 illustrate example source management units in folding operations in accordance with some embodiments of the present disclosure.

FIG. 6 illustrates example cache management units in folding operations in accordance with some embodiments of the present disclosure.

FIG. 7 illustrates example logical to physical (L2P) metadata in accordance with some embodiments of the present disclosure.

FIG. 8 illustrates example destination management units in folding operations in accordance with some embodiments of the present disclosure.

FIG. 9 illustrates example two-pass programming operations in accordance with some embodiments of the present disclosure.

FIG. 10 is a flow diagram of an example method to perform folding management for two-pass programming operations in accordance with some embodiments of the present disclosure.

FIG. 11 is a block diagram of an example computer system in which embodiments of the present disclosure may operate.

### DETAILED DESCRIPTION

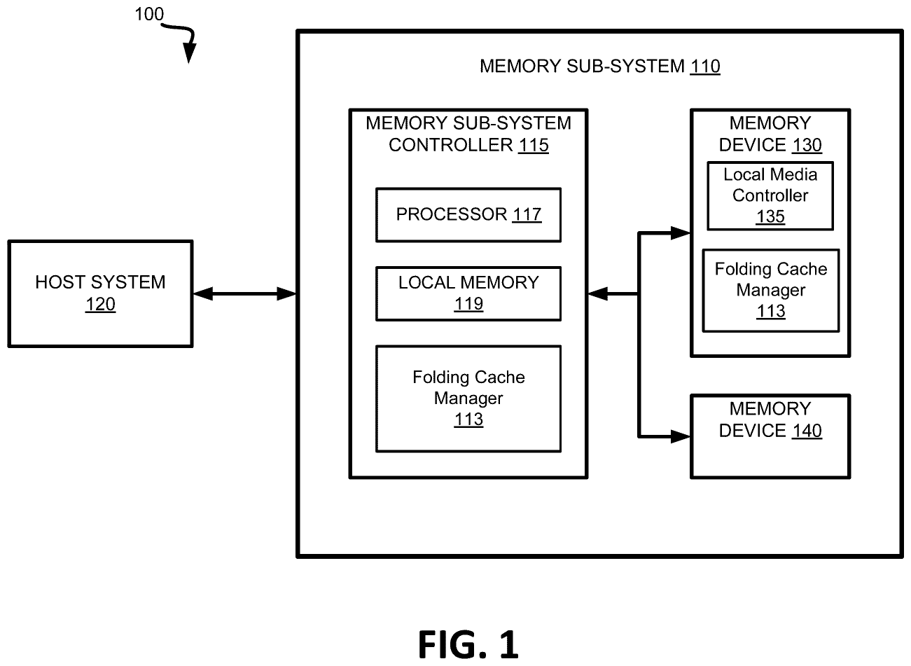

Aspects of the present disclosure are directed to folding management for two-pass programming of memory devices. A memory sub-system can be a storage device, a memory module, or a combination of a storage device and memory module. Examples of storage devices and memory modules are described below in conjunction with FIG. 1. In general, a host system can utilize a memory sub-system that includes one or more components, such as memory devices that store data. The host system can provide data to be stored at the memory sub-system and can request data to be retrieved from the memory sub-system.

A memory sub-system can include high density non-volatile memory devices where retention of data is desired when no power is supplied to the memory device. One example of non-volatile memory devices is a negative-and (NAND) memory device. Other examples of non-volatile memory devices are described below in conjunction with FIG. 1. A non-volatile memory device is a package of one or more dies. Each die can consist of one or more planes. For some types of non-volatile memory devices (e.g., NAND devices), each plane consists of a set of physical blocks. Each block consists of a set of pages. Each page consists of a set of memory cells (“cells”). A cell is an electronic circuit that stores information. Depending on the cell type, a cell can store one or more bits of binary information, and has various logic states that correlate to the number of bits being stored. The logic states can be represented by binary values, such as “0” and “1”, or combinations of such values.

A memory device can include multiple memory cells arranged in a two-dimensional grid. The memory cells are etched onto a silicon wafer in an array of columns (also hereinafter referred to as bitlines) and rows (also hereinafter referred to as wordlines). A wordline can refer to one or more rows of memory cells of a memory device that are used with one or more bitlines to generate the address of each of the memory cells. The intersection of a bitline and wordline constitutes the address of the memory cell. A block hereinafter refers to a unit of the memory device used to store data and can include a group of memory cells, a wordline group, a wordline, or individual memory cells. One or more blocks can be grouped together to form a plane of the memory device in order to allow concurrent operations to take place on each plane. The memory device can include circuitry that performs concurrent memory page accesses of two or more memory planes. For example, the memory device can include a respective access line driver circuit and power circuit for each plane of the memory device to facilitate concurrent access of pages of two or more memory planes, including different page types.

As described above, a die can contain one or more planes. A memory sub-system can use a striping scheme to treat various sets of data as units when performing data operations (e.g., write, read, erase, etc.). A die stripe refers to a collection of planes that are treated as one unit when writing, reading, or erasing data. A controller of a memory device (i.e., a memory sub-system controller, a memory device controller, etc.) can execute the same operation, in parallel, at each plane of a die stripe. A block stripe is a collection of blocks, at least one from each plane of a die stripe, that are treated as a unit. The blocks in a block stripe can be associated with the same block identifier (e.g., block number) at each respective plane. A page stripe is a set of pages having the same page identifier (e.g., the same page number), across a block stripe, and treated as a unit.

One type of cell is a single level cell (SLC), which stores 1 bit per cell and defines 2 logical states (“states”) (“1” or “L0” and “0” or “L1”) each corresponding to a respective V_{T} level. For example, the “1” state can be an erased state and the “0” state can be a programmed state (L1). Another type of cell is a multi-level cell (MLC), which stores 2 bits per cell and defines 4 states (“11” or “L0”, “10” or “L1”, “01” or “L2” and “00” or “L3”) each corresponding to a respective V_{T} level. For example, the “11” state can be an erased state and the “01”, “10” and “00” states can each be a respective programmed state. Another type of cell is a triple level cell (TLC), which stores 3 bits per cell and defines 8 states (“111” or “L0”, “110” or “L1”, “101” or “L2”, “100” or “L3”, “011” or “L4”, “010” or “L5”, “001” or “L6”, and “000” or “L7”) each corresponding to a respective V_{T} level. For example, the “111” state can be an erased state and each of the other states can be a respective programmed state. Another type of a cell is a quad-level cell (QLC), which stores 4 bits per cell and defines 16 states L0-L15, where L0 corresponds to “1111” and L15 corresponds to “0000”. Another type of cell is a penta-level cell (PLC), which stores 5 bits per cell and defines 32 states. Other types of cells are also contemplated. Thus, an n-level cell can use 2ⁿ levels of charge to store n bits. A memory device can include one or more arrays of memory cells such as SLCs, MLCs, TLCs, QLCS, PLCs, etc. or any combination of such. For example, a memory device can include an SLC portion, and an MLC portion, a TLC portion, a QLC portion, or a PLC portion of cells.

Each type of memory cell (e.g., SLCs, MLCs, TLCs and QLCs) can exhibit different characteristics and advantages. For example, an SLC can have a lower read latency (e.g., how long it takes for data stored at the SLC to be read), a faster programming time (e.g., how long it takes to program data received from the host system to the cell for storage) and a greater reliability for data stored at the SLC than the other types of memory cells. Although SLCs offer superior performance characteristics, manufacturing memory devices that include only SLC memory cells can be less cost-effective in comparison with memory devices having higher density cells (e.g., MLCs, TLCs and QLCs), which store more bits per cell. Accordingly, some memory cells can be configured as SLCs, while the rest of the memory cells can be higher density cells. Data is first written to the SLC portion of the memory device and later transferred to a higher density portion of the memory device when the memory sub-system is not busy servicing host requests. The use of SLC cells in this way can be termed a “SLC cache.” The SLC cache provides a balance between the speed of SLC memory cells with the storage capacity of higher density memory cells. In some memory implementations, as the device fills up, memory cells configured as SLC cache are migrated to higher density memory cells to increase data storage capacity.

A host system can initiate a memory access operation (e.g., a programming or write operation, a read operation, an erase operation, etc.) on a memory sub-system. For example, the host system can transmit a request to a memory sub-system controller, to program data to and/or read data from a memory device of the memory sub-system. Such data is referred to herein as “host data.” The memory sub-system controller can execute one or more operations to access the host data in accordance with the request. Host data can be encoded using error-correcting code (ECC)) to correct data errors that can occur during transmission or storage. In particular, the host data can be encoded using redundancy metadata (e.g., parity data such as one or more parity bits) to form a codeword. The parity data allows the memory sub-system controller to detect a number of errors that may occur anywhere in the host data, and often to correct these errors without retransmission.

In some systems, a memory sub-system can routinely perform data integrity checks to verify that the data stored at the block can be reliably read. In an example, the memory sub-system controller can select a block and perform the data integrity check on some to all of the pages of the block. During the data integrity check, which can measure and collect information about error rates associated with data, values of a data state metric are determined for data stored at the block. “Data state metric” herein shall refer to a quantity that is measured or inferred from the state of data stored on a memory device. Specifically, data state metrics may reflect the state of the temporal voltage shift, the degree of read disturb, and/or other measurable functions of the data state. A composite data state metric is a function (e.g., a weighted sum) of a set of component state metrics. One example of a data state metric is bit error count (BEC). Another example of a data state metric is residual bit error rate (RBER). The RBER corresponds to a number of bit errors per unit of time that the data stored at the data block experiences (e.g., BEC/total bits read). A data state metric value exceeding a transfer threshold criterion can trigger a media management operation (e.g., a folding operation).

The folding operation involves copying data from a source management unit (e.g., a block, superblock, a page, etc.) to a destination management unit (e.g., a block, superblock, a page, etc.) available on the memory device. Folding operations can be performed in various scenarios. In one instance, the folding operation includes retrieving data from the source management units (e.g., as a cache) and programming the data on certain types of memory cells in the destination management units. For example, the destination management units include memory cells of quadruple-level cell (QLC) type, storing a 4-bit value per cell. A two-pass programming operation can be introduced in order to mitigate the program disturb, which is caused by cell-to-cell interference where a bit is unintentionally programmed from a “1” to a “0” during a page-programming event. Instead of directly programming data to the QLC, the two-pass programming operation specifies that data is to be written in a first pass to the single-level cell (SLC) then in a second pass to the QLC. The first pass is not final or ready to service read operations. Data in the second pass is considered finalized and ready to service read operations. The two passes together is a two-pass programming operation.

In another instance, the folding operations occurs as garbage collection in a memory device such as quadruple-level cell (QLC) memory device. Garbage collection is a process to recover free space by relocating pages with data to new blocks, and erasing old blocks. Specifically, a block can include valid data pages and data pages that are no longer needed (e.g., stale pages). Garbage collection generally involves copying only the valid data pages from a source block to a destination block and then erasing the source block to free the space. The two-pass programming also occurs when the garbage collection is performed in the QLC memory devices. This is a demand for management on the folding operations in the two-pass programming memory devices such as QLC memory devices. For example, after completing the first pass but before completing the second pass of the two-pass programming operation, the data stored in the source management units cannot be deleted because the data needs to be retrieved again for performing the second pass, and thus the source management units cannot be released for other use.

Aspects of the present disclosure address the above and other deficiencies by utilizing a new cache for the folding operation and implementing firmware to manage the cache and facilitate the folding operation, where the folding operation migrates host data stored at a particular number of data locations of the memory sub-system (“source management units” such as one or more logical units (LUNs) (e.g., a die, a plane, a block, a page)) to other data locations of the memory sub-system (“destination management units” such as one or more logical units (LUNs) (e.g., a die, a plane, a block, a page)). Specifically, the firmware (e.g., a folding cache manager) running on a controller of a memory sub-system or a memory device can retrieve valid data from source management units (e.g., a source page stripe), for example, in a predefined order of source management units. The firmware can store the retrieved valid data in cache management units in a sequential order of cache management units. While storing the valid data, the firmware can generate physical to logical (P2L) metadata of the valid data and store that P2L metadata along with the valid data in the cache management units. The P2L metadata of the valid data maps the logical address of the valid data to the physical address corresponding to the destination management units. The firmware may keep storing the valid data until the amount of stored valid data satisfies a threshold criterion, such as reaches a predetermined threshold of capacity (e.g., all valid data in a source management unit is stored, or valid data fully occupies a cache management unit). Upon the threshold criterion being satisfied, the firmware may send the valid data, in an order that is the same as the sequential order in which the data stored, to the destination management units. The locations of valid data being stored in the destination management units are determined based on the P2L metadata. The firmware (or a local controller on the memory device including the destination management units) can program the valid data using two-pass programming operations to the destination management units.

In some implementations, the source management unit is a SLC page stripe or a QLC page stripe, the destination management unit is a QLC page stripe, and the cache management unit is a dynamic random access memory (DRAM) stripe. A page stripe may be an ordered set of pages having the same page identifier (e.g., the same page number), across a block stripe, and a block stripe is an ordered collection of blocks of a memory device, one block from each plane of each logical unit (LUN) (e.g., a die) of the memory device, such that the collection of pages is treated as an elementary programmable unit. The SLC page stripe thus represents the elementary programmable unit of SLCs and the QLC page stripe represents the elementary programmable unit of QLCs. The DRAM stripe is an ordered set of pages of DRAM. Although SLC, QLC, DRAM are used as examples of the memory devices, other cell type memory devices (e.g., MLC, TLC, etc.) and/or other types of memory devices are also applicable.

As an illustrative example of a folding operation from SLC page stripe(s) to QLC page stripe(s), the firmware can retrieve the valid data from the SLC page stripe(s) and store it sequentially in the DRAM stripe. While storing the valid data, the firmware may generate P2L metadata of the valid data and store it along with the valid data in the DRAM stripe. The P2L metadata indicates the destination location for storing the respective data. The firmware may determine whether the amount of stored valid data satisfies a threshold criterion, such as whether the amount reaches a predetermined threshold of capacity (e.g., all valid data in four SLC page stripes is stored, or valid data fully occupies a DRAM stripe). Responsive to determining that the amount of stored valid data satisfies the threshold criterion, the firmware may send the valid data, in an order same as the sequential order stored in the DRAM stripe, to the destination QLC page stripe. The firmware may write the valid data in the destination QLC page stripe using two-pass programming operation.

As an illustrative example of folding operation from QLC page stripe(s) to QLC page stripe(s), the firmware can retrieve the valid data from the QLC page stripe(s) and store it sequentially in the DRAM stripe. While storing the valid data, the firmware may generate P2L metadata of the valid data and store it along with the valid data in the DRAM stripe. The P2L metadata indicates the destination location for storing the respective data. The firmware may determine whether the amount of stored valid data satisfies a threshold criterion, such as reaches a predetermined threshold of capacity (e.g., all valid data in one QLC page stripe is stored, or valid data fully occupies a DRAM stripe). Responsive to determining that the amount of stored valid data satisfies the threshold criterion, the firmware may send the valid data, in an order same as the sequential order stored in the DRAM stripe, to the destination QLC page stripe. The firmware may write the valid data in the destination QLC page stripe using two-pass programming operation.

Advantages of the present disclosure include managing folding operations such as maintaining write order of sequential data, managing the DRAM cache used in the folding operations, handling P2L metadata generation, guiding the write location of host data and P2L to the destination memory cells, and managing the programming operation on the destination memory cells across the coarse and fine programming gap. The source memory cells can be released for other use when the data is stored in the DRAM cache and there is no need to wait for programming the data to the destination memory cells. Further, the two-pass programming operation does not require retrieving data from the source memory cells for the second time, allowing the source memory cells to be released earlier for other use. Various aspects of the above referenced methods and systems are described in details herein below by way of examples, rather than by way of limitation.

FIG. 1 illustrates an example computing system 100 that includes a memory sub-system 110 in accordance with some embodiments of the present disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a combination of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to different types of memory sub-system 110. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller, CXL controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a serial advanced technology attachment (SATA) interface, a compute express link (CXL) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 120 and the memory sub-system 110. The host system 120 can further utilize an NVM Express (NVMe) interface to access the memory components (e.g., the one or more memory device(s) 130) when the memory sub-system 110 is coupled with the host system 120 by the physical host interface (e.g., PCIe or CXL bus). The physical host interface can provide an interface for passing control, address, data, and other signals between the memory sub-system 110 and the host system 120. FIG. 1 illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device(s) 130) include negative-and (NAND) type flash memory and write-in-place memory, such as three-dimensional cross-point (“3D cross-point”) memory. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory device(s) 130 can include one or more arrays of memory cells. One type of memory cell, for example, single level cells (SLC) can store one bit per cell. Other types of memory cells, such as multi-level cells (MLCs), triple level cells (TLCs), and quad-level cells (QLCs), can store multiple bits per cell. In some embodiments, each of the memory devices 130 can include one or more arrays of memory cells such as SLCs, MLCs, TLCs, QLCs, or any combination of such. In some embodiments, a particular memory device can include an SLC portion, and an MLC portion, a TLC portion, or a QLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory components such as a 3D cross-point array of non-volatile memory cells and NAND type flash memory (e.g., 2D NAND, 3D NAND) are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, electrically erasable programmable read-only memory (EEPROM).

A memory sub-system controller 115 (or controller 115 for simplicity) can communicate with the memory device(s) 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processor 117 (e.g., a processing device) configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. 1A has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory device(s) 130. The memory sub-system controller 115 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory device(s) 130. The memory sub-system controller 115 can further include host interface circuitry to communicate with the host system 120 via the physical host interface. The host interface circuitry can convert the commands received from the host system into command instructions to access the memory device(s) 130 as well as convert responses associated with the memory device(s) 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory device(s) 130.

In some embodiments, the memory device(s) 130 include local media controllers 135 that operate in conjunction with memory sub-system controller 115 to execute operations on one or more memory cells of the memory device(s) 130. An external controller (e.g., memory sub-system controller 115) can externally manage the memory device 130 (e.g., perform media management operations on the memory device(s) 130). In some embodiments, a memory device 130 is a managed memory device, which is a raw memory device (e.g., memory array 104) having control logic (e.g., local controller 135) for media management within the same memory device package. An example of a managed memory device is a managed NAND (MNAND) device. Memory device(s) 130, for example, can each represent a single die having some control logic (e.g., local media controller 135) embodied thereon. In some embodiments, one or more components of memory sub-system 110 can be omitted.

In one embodiment, memory sub-system 110 includes a folding cache manager 113 that can manage folding operations. In some embodiments, memory sub-system controller 115 includes at least a portion of folding cache manager 113. In some embodiments, folding cache manager 113 is part of host system 110, an application, or an operating system. In other embodiments, local media controller 135 includes at least a portion of folding cache manager 113 and is configured to perform the functionality described herein. Further details with regards to the operations of folding cache manager 113 are described below.

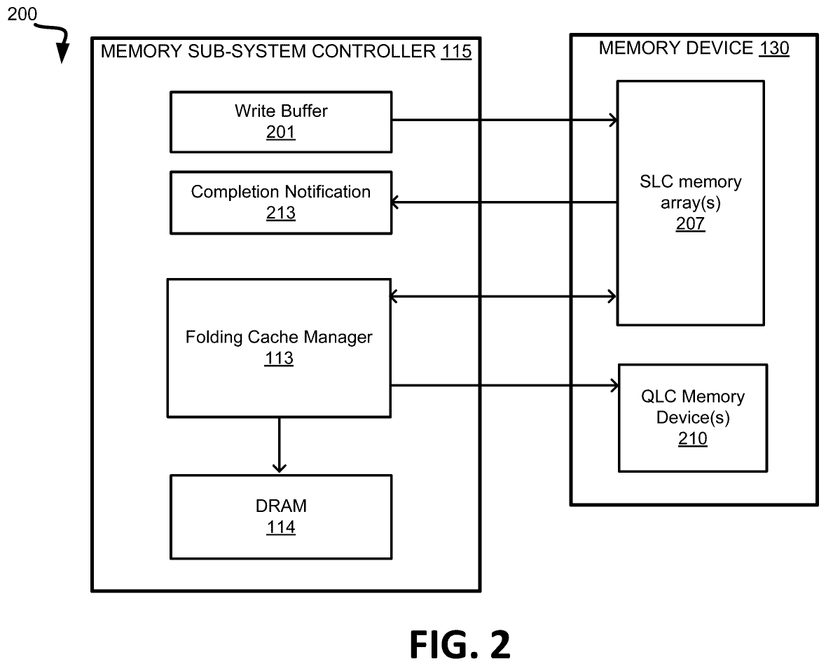

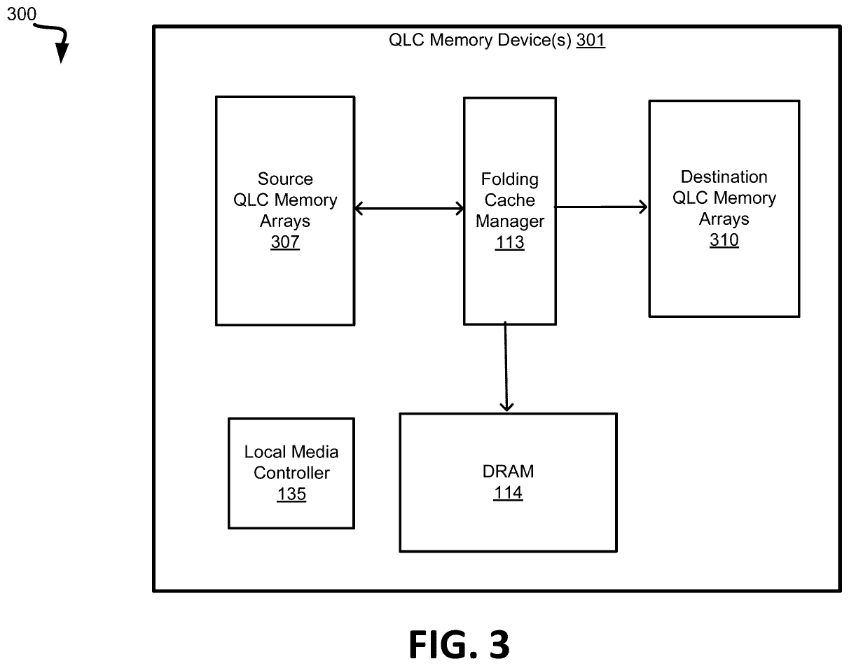

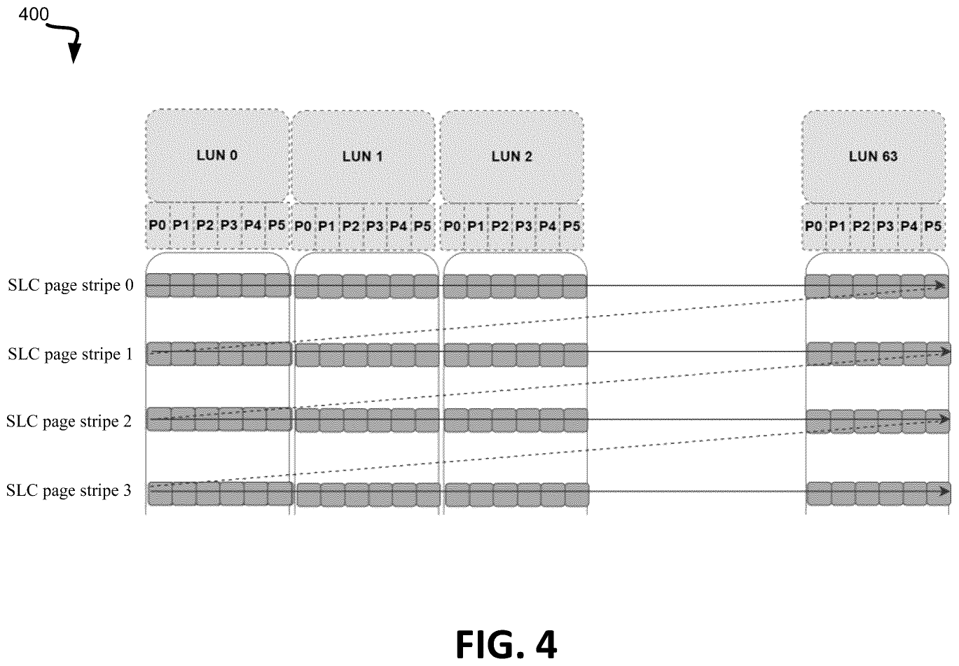

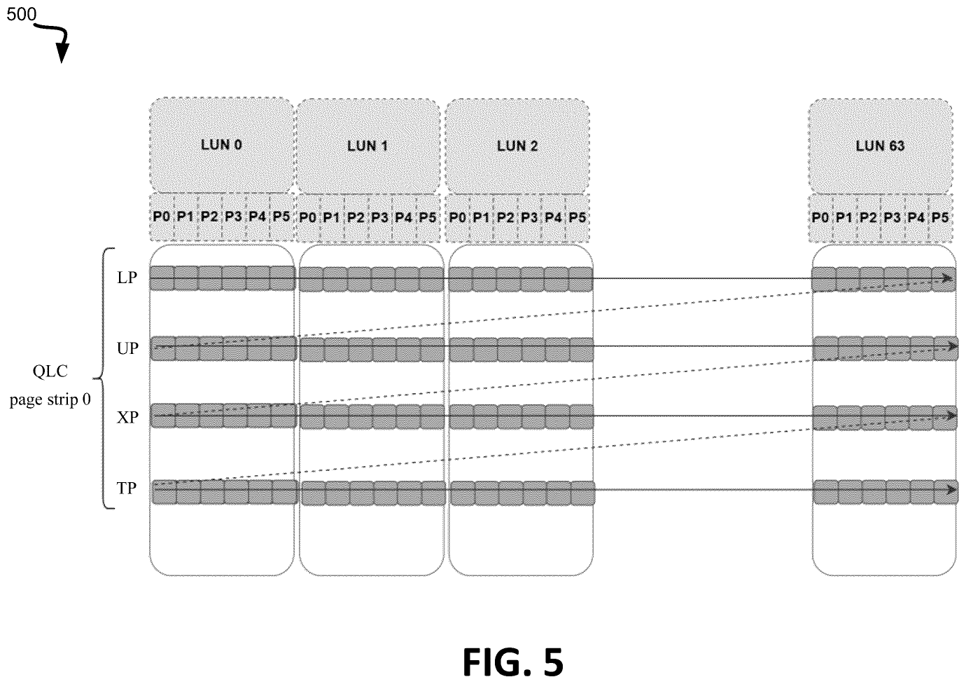

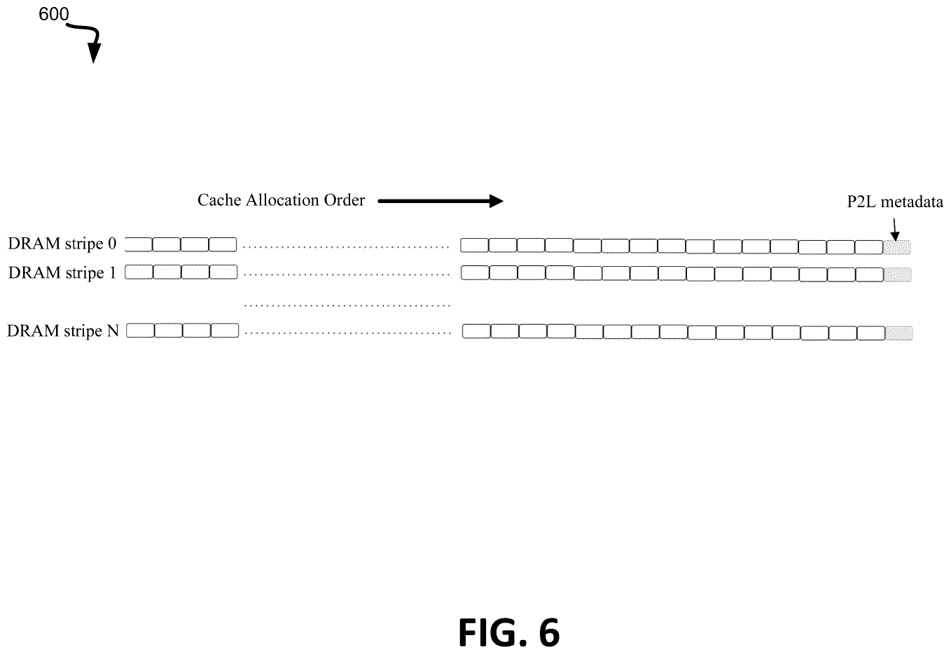

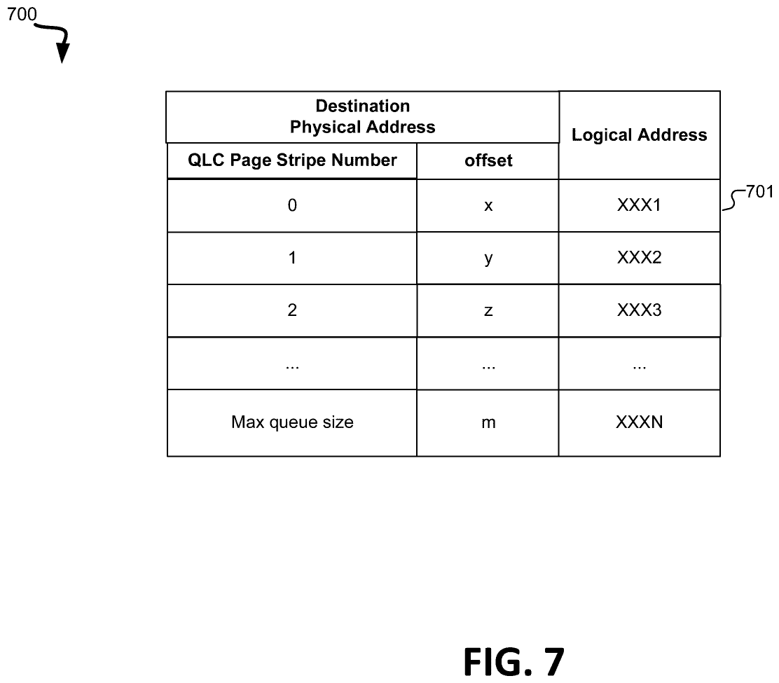

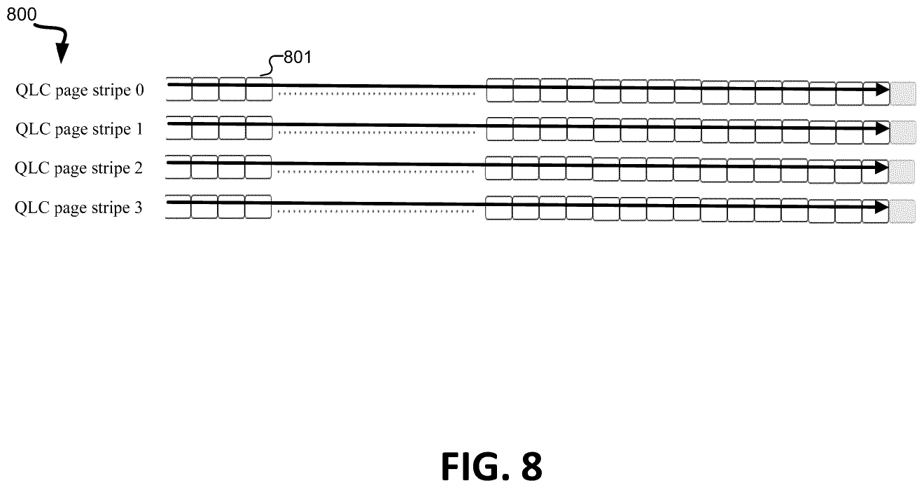

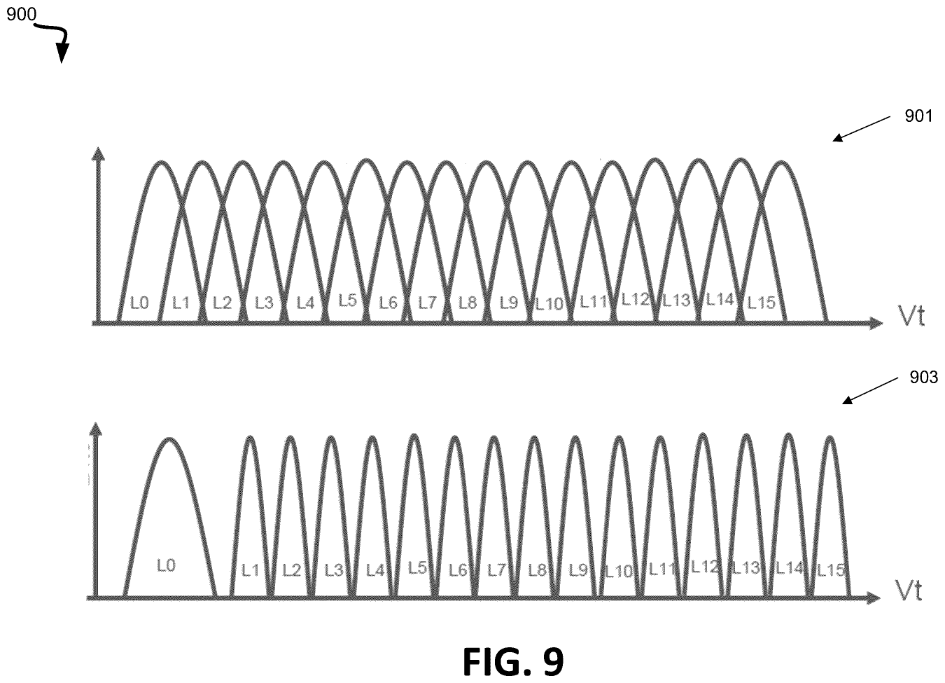

FIG. 2 illustrates an example of performing folding operations from source SLC management units (e.g., SLC page stripes) to destination QLC management units (e.g., QLC page stripes), and FIG. 4 illustrates example source SLC management units. FIG. 3 illustrates an example of performing folding operations from source QLC management units (e.g., QLC page stripes) to destination QLC management units (e.g., QLC page stripes), and FIG. 5 illustrates example source QLC management units. FIG. 6 illustrates example cache management units. FIG. 7 illustrates example journal entries written in the cache management units. FIG. 8 illustrates example destination QLC management units. FIG. 9 illustrates example two-pass programming operation involved in the folding operations.

FIG. 2 illustrates a block diagram of a system that performs folding operations in accordance with some embodiments of the present disclosure. System 200 can represent memory sub-system 110 of FIG. 1. Referring to FIG. 2, system 200 can include single-level cell (SLC) memory arrays 207 (as part of memory device 130), quad-level cell (QLC) memory device 210 (as part of memory device 130), and memory controller 115. Memory controller 115 can include write buffer 201, folding cache manager 113, DRAM 114, and completion notification 213.

Write buffer 201 can store write commands submitted to the memory sub-system by the host system 120 and/or write commands initiated by controller 115 (e.g., garbage collection). Controller 115 can execute the write commands to SLC page stripes in the SLC memory arrays 207. In some embodiments, the QLC memory device 210 can be part of memory devices 130-140. In some embodiments, the SLC memory arrays 207 can be part of memory devices 130-140. In some embodiments, the DRAM 114 can be part of controller 115 or memory devices 130-140. The DRAM can work as a cache for the folding operation to migrate the data from the SLC memory arrays 207 to QLC memory device 210.

The folding cache manager 113 can manage the folding operations to migrate data from SLC memory arrays 207 through the DRAM 114 to QLC memory device 210. For example, the folding cache manager 113 can assign a set of SLC page stripes for the folding operation. FIG. 4 illustrates a set of logical units (LUNs) (e.g., LUN0-LUN63), where each LUN includes a set of planes (e.g., P0-P5), where each plane includes a set of blocks (not shown), where each block includes a set of pages, and the pages with the same identifier from each block and each plane and each LUN collectively form a page stripe (e.g., SLC page stripe 0-SLC page stripe 3). Referring to FIG. 4, the folding cache manager 113 can retrieve the data stored in the SLC page stripes 0-3. The folding cache manager 113 can retrieve the valid data in the sequential order of SLC page stripe 0, SLC page stripe 1, SLC page stripe 2, SLC page stripe 3 as shown in the arrow direction in FIG. 4.

The folding cache manager 113 can store the retrieved data in the DRAM 114. The folding cache manager 113 can allocate the DRAM 114 in a predefined order. Referring to FIG. 6, the folding cache manager 113 can allocate the DRAM stripe 0 in the sequential order of the memory space as shown in the arrow direction of cache allocation order in FIG. 6. While storing the retrieved data, the folding cache manager 113 can generate P2L metadata, where the P2L metadata maps logical addresses of the retrieved data to physical addresses corresponding to the destination QLC memory device 210 (i.e., destination physical addresses). The folding cache manager 113 can store the P2L metadata along with the retrieved data. Referring to FIG. 6, the folding cache manager 113 can store the P2L metadata at the end of the DRAM stripe 0. The example P2L metadata is illustrated in FIG. 7.

Referring to FIG. 7, P2L metadata 700 includes one or more entries for write operations to a memory device. Each entry may include the logical address of the corresponding data and the destination physical address that references a location for storing the data in the destination management units. As shown in FIG. 7, the entry 701 may include the logical address (e.g., XXX1) and the destination physical address that are identified by a field indicating the QLC page stripe number (e.g., 0) and a field indicating an offset in the QLC page stripe (e.g., x). The QLC page stripe number may identify the QLC page stripe of the QLC memory device 210. For example, the QLC page stripe number 0 in P2L metadata 700 may identify QLC page stripe 0 in FIG. 8. The offset in the QLC page stripe may identify the specific location in the QLC page stripe. For example, offset x associated with the QLC page stripe number 0 in P2L metadata 700 may identify the specific location 801 in QLC page stripe 0 in FIG. 8. As such, the folding cache manager 113 can insert P2L metadata entries for the data in response to writing the data to the DRAM 114.

Referring back to FIG. 2, the folding cache manager 113 can keep writing the retrieved data to the DRAM 114 and the corresponding P2L metadata. In one embodiment, when the folding cache manager 113 determines that the amount of data written to DRAM 114 satisfies a threshold criterion, the folding cache manager 113 can migrate the data from DRAM 114 to QLC memory device 210. Specifically, the folding cache manager 113 can determine whether the data written in the DRAM 114 reaches a predetermined threshold of capacity associated with DRAM 114 (e.g., data occupying one full DRAM stripe) or a predetermined threshold of capacity associated with SLC memory arrays 207 (e.g., a certain number of SLC page stripes of valid data).

Responsive to determine that the data written in the DRAM 114 reaches the predetermined threshold of capacity, the folding cache manager 113 can send the data stored in the DRAM 114 to the QLC memory device 210 for programming. For example, the folding cache manager 113 can determine that the DRAM stripe 0 is fully written with data and then send the data in the DRAM stripe 0 to the QLC memory device 210 for programming. As another example, the folding cache manager 113 can determine that valid data stored in four SLC page stripes 0-3 have been written to the DRAM stripe 1, and then send the data in the DRAM stripe 1 to the QLC memory device 210 for programming.

To program the data, the folding cache manager 113 can assign a set of QLC page stripes for the folding operation. Referring to FIG. 8, the folding cache manager 113 can assign QLC page stripe 0, QLC page stripe 1, QLC page stripe 2, QLC page stripe 3 in the sequential order of the memory space as shown in the arrow direction in FIG. 8. The folding cache manager 113 can perform a two-pass programming operation on the set of QLC page stripes to program the data to QLC memory device 210. During the first pass of the two-pass programming operation, a first set of voltages is applied. During the second pass of the two-pass programming operation, a second set of voltages is applied. An example two-pass programming operation is illustrated in FIG. 9.

Referring to FIG. 9, each programming pass 901, 903 in the two-pass programming operation 900 would apply appropriate programming voltages to a given wordline in order place appropriate charges on the charge storage nodes of the memory cells that are connected to the wordline. In some embodiments, the memory controller can implement a two-pass programming algorithm, which involves programming the lower page (LP) bits, the upper page (UP) bits, and the extra page (XP) bits of the memory cells by the first programming pass, followed by programming the top page (TP) bits of the memory cells by the second programming pass. This algorithm can be referred to as 8-16 programming algorithm, to reflect the number of memory cell states programmed by each pass. Thus, each memory cell stores sixteen states that are programmable by two sequential programming passes. Notably, the TP data is still stored in DRAM 114 during the second programming pass.

In some embodiments as illustrated in FIG. 9, the two-pass programming operation can implement a coarse-fine programming algorithm. A first graph 901 illustrates the first programming pass, which forms, for each memory cell, sixteen logical states after coarse programming. The graph 901 illustrates an example of a set of threshold voltage distributions after coarse programming. Coarse programming can be compared to first pass programming in which the Vt distributions are highly overlapped when coarse programming Vt distributions, e.g., as is the case in programming QLC memory. Due to this overlapping of the Vt distributions, the coarse-programmed sets of threshold Vt distributions may also be referred to herein as intermediate Vt distributions. This overlapping occurs due to less precise programming in which each Vt distribution widely covers a range of threshold voltage that coarsely approximates a more accurate (finer) threshold voltage range that is intended for each respective Vt distribution. A second graph 903 illustrates the second programming pass forms, for each memory cell, sixteen logical states after fine programming. The graph 903 illustrates the example of the set of threshold voltage distributions after fine programming. When fine programming is completed, e.g., to a final set of Vt distributions, each Vt distribution is more finely defined over a focused threshold voltage range intended for each respective logical state. When this occurs, the read window margins between respective Vt distributions are widened such that individual logical states across different memory cells of a set of memory cells can be distinguished when read.

Referring back to FIG. 2, the memory controller 115 can communicate to a host 120, a notification the write operation has been completed. When the write operation completes, a completion notification 213 is sent back to the host process that initiated the write operations.

FIG. 3 illustrates a block diagram of a system that performs folding operations from source QLC memory arrays to destination QLC memory arrays in accordance with some embodiments of the present disclosure. System 300 can represent memory device 130 of FIG. 1. Referring to FIG. 3, system 300 can be a quad-level cell (QLC) memory device 301 (as part of memory devices 130-140). The QLC memory device 301 can include a local media controller 135, source QLC memory arrays 307, folding cache manager 113, DRAM 114, and destination QLC memory arrays 310.

The local media controller 135 can store write commands submitted to the memory device 301 by the host system 120 and/or write commands initiated by controller 115 (e.g., garbage collection). The local media controller 135 can execute the write commands to QLC page stripes in the QLC memory arrays 307. In some embodiments, the DRAM 114 can be part of local media controller 135. The DRAM can work as a cache for the folding operation to migrate the data from the QLC memory arrays 307 to QLC memory arrays 310.

The folding cache manager 113 can manage the folding operations to migrate data from QLC memory arrays 307 through the DRAM 114 to QLC memory arrays 310. For example, the folding cache manager 113 can assign a set of QLC page stripes for the folding operation. FIG. 5 illustrates a set of logical units (LUNs) (e.g., LUN0-LUN63), where each LUN includes a set of planes (e.g., P0-P5), where each plane includes a set of blocks (not shown), where each block includes a set of pages, and the pages with the same identifier from each block and each plane and each LUN collectively form a page stripe (e.g., QLC page stripe 0 including LP, UP, XP, and TP). Referring to FIG. 5, the folding cache manager 113 can retrieve the data stored in the QLC page stripe 0, which comprises LP, UP, XP, and TP. The folding cache manager 113 can retrieve the data in the sequential order of LP, UP, XP, and TP as shown in the arrow direction in FIG. 5.

The folding cache manager 113 can store the retrieved data in the DRAM 114. The folding cache manager 113 can allocate the DRAM 114 in a predefined order. Referring to FIG. 6, the folding cache manager 113 can allocate the DRAM stripe 0 in the sequential order of the memory space as shown in the arrow direction of cache allocation order in FIG. 6. While storing the retrieved data, the folding cache manager 113 can generate P2L metadata, where the P2L metadata maps logical addresses of the retrieved data to physical addresses corresponding to the destination QLC memory device 210 (i.e., destination physical addresses). The folding cache manager 113 can store the P2L metadata along with the retrieved data. Referring to FIG. 6, the folding cache manager 113 can store the L2P metadate at the end of the DRAM stripe 0. The example P2L metadata is illustrated in FIG. 7.

The folding cache manager 113 can keep writing the retrieved data to the DRAM 114 and the corresponding P2L metadata In one embodiment, when the folding cache manager 113 determines that the amount of data written to DRAM 114 satisfies a threshold criterion, the folding cache manager 113 can migrate the data from DRAM 114 to QLC memory device 210. Specifically, the folding cache manager 113 can determine whether the data written in the DRAM 114 reaches a predetermined threshold of capacity associated with DRAM 114 (e.g., data occupying one full DRAM stripe) or a predetermined threshold of capacity associated with QLC memory arrays 307 (e.g., a certain number of QLC page stripes of valid data).

Responsive to determine that the data written in the DRAM 114 reaches the predetermined threshold of capacity, the folding cache manager 113 can send the data stored in the DRAM 114 to the QLC memory arrays 310 for programming. For example, the folding cache manager 113 can determine that the DRAM stripe 0 is fully written with data and then send the data in the DRAM stripe 0 to the QLC memory device 210 for programming. As another example, the folding cache manager 113 can determine that valid data stored in one QLC page stripe 0 have been written to the DRAM stripe 1, and then send the data in the DRAM stripe 1 to the QLC memory device 210 for programming.

To program the data, the folding cache manager 113 can assign a set of QLC page stripes for the folding operation. Referring to FIG. 8, the folding cache manager 113 can assign QLC page stripe 0, QLC page stripe 1, QLC page stripe 2, QLC page stripe 3 in the sequential order of the memory space as shown in the arrow direction in FIG. 8. The folding cache manager 113 can perform a two-pass programming operation on the set of QLC page stripes to program the data to QLC memory arrays 310. During the first pass of the two-pass programming operation, a first set of voltages is applied. During the second pass of the two-pass programming operation, a second set of voltages is applied. The example two-pass programming operation is illustrated in FIG. 9. The local media controller 135 can communicate to the host system 120 or the controller 115, a notification the write operation has been completed. When the write operation completes, a completion notification can be sent back to the host process that initiated the write operations.

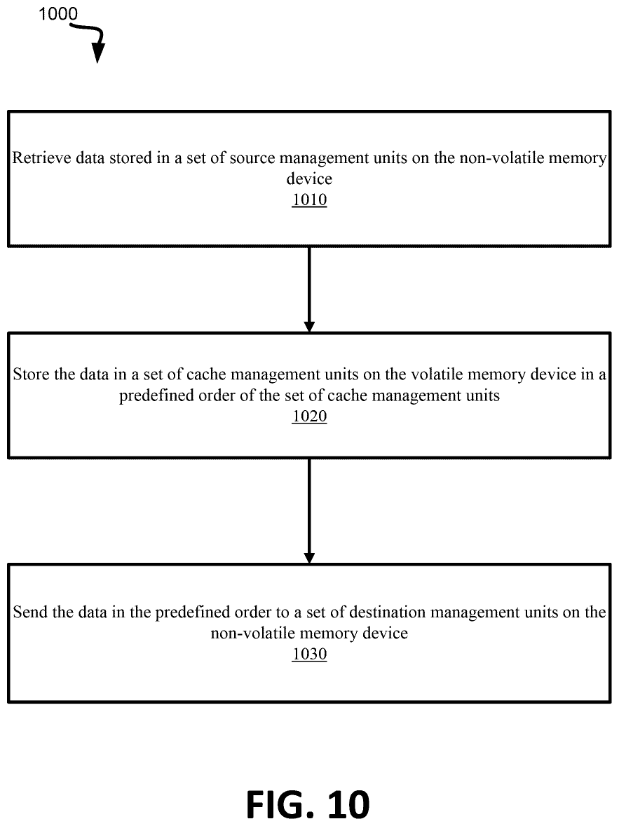

FIG. 10 is a flow diagram of an example method to manage the folding operations in accordance with some embodiments of the present disclosure. The method 1000 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 1000 is performed by the folding cache manager 113 of FIGS. 1-3. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 1010, the processing device may retrieve data stored in a set of source management units (e.g., SLC page stripes 0-3 in FIG. 4 or QLC page stripe 0 in FIG. 5) on the non-volatile memory device (e.g., SLC memory arrays 207 in FIG. 2 or QLC memory arrays 307 in FIG. 3). In some implementations, the data is retrieved in a sequential order of valid data stored in the set of source management units. In some implementations, the processing device may receive a request to perform a folding operation to migrate the data stored in a set of source management units to a set of destination management units, and responsive to receiving the request, retrieve the data stored in the set of source management units.

At operation 1020, the processing device may store the data in a set of cache management units (e.g., DRAM stripe 0 in FIG. 6) on the volatile memory device (e.g., DRAM 114) in a predefined order of the set of cache management units (e.g., cache allocation order shown in FIG. 6). In some implementations, the predefined order of the set of cache management units is a sequential order of a dynamic random access memory (DRAM) stripe. In some implementations, the processing device may generate logical to physical (L2P) metadata associated with the data during storing the data, and the P2L metadata maps one or more logical addresses of the data to one or more physical addresses corresponding to the set of destination management units on the non-volatile memory device. In some implementations, the processing device may store the P2L metadata in the set of cache management units on the non-volatile memory device.

In some implementations, the processing device may store the data in the set of cache management units until an amount of stored valid data satisfies a threshold criterion. In some implementations, the processing device may send the data to the set of destination management units responsive to determining that the amount of stored valid data satisfies the threshold criterion.

At operation 1030, the processing device may send the data in the predefined order to a set of destination management units (e.g., QLC page stripes (e.g., QLC page stripe 0 in FIG. 8) on the non-volatile memory device (e.g., QLC memory devices 210 in FIG. 2 or QLC memory arrays 310 in FIG. 3). In some implementations, the processing device may program the data on the set of destination management units according to the one or more physical addresses in the P2L metadata (e.g., P2L metadata 700 in FIG. 7). In some implementations, the processing device may perform a two pass programming operation to program the data on the set of destination management units, where the two pass programming operation comprises performing a first program pass to apply a first set of voltages and performing a second program pass to apply a second set of voltages. In some implementations, responsive to determining that the second program pass of the two pass programming operation is completed, the processing device may release the set of cache management units.

In some implementations, the set of source management units comprises a set of single level cell (SLC) page stripes, the set of destination management units comprises a set of quad level cell (QLC) page stripes, and the volatile memory device comprises a dynamic random access memory (DRAM) device. In some implementations, the set of source management units comprises a first set of quad level cell (QLC) page stripes, the set of destination management units comprises a second set of quad level cell (QLC) page stripes, and the volatile memory device comprises a dynamic random access memory (DRAM) device.

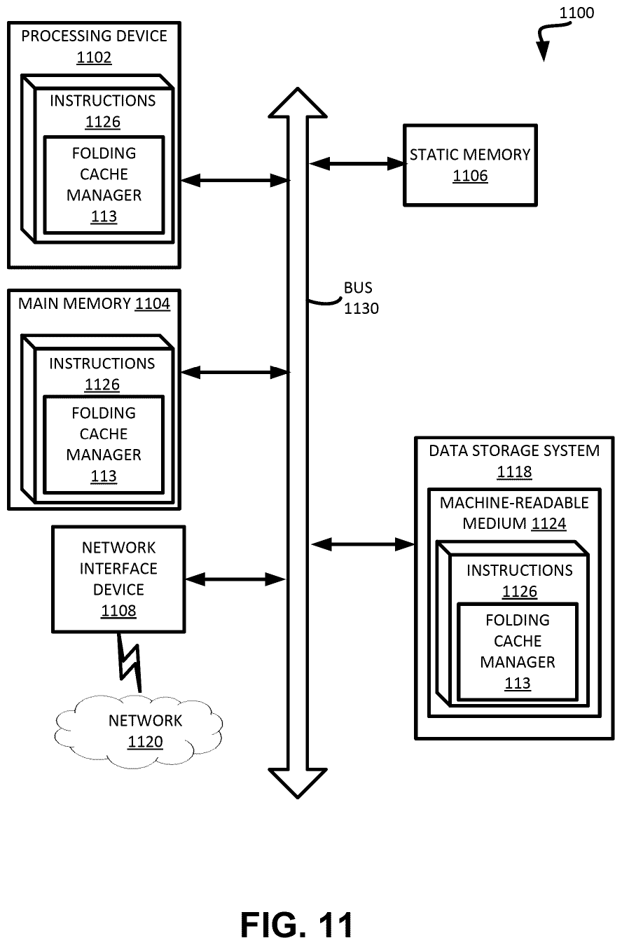

FIG. 11 illustrates an example machine of a computer system 1100 within which a set of instructions, for causing the machine to perform any one or more of the methodologies discussed herein, can be executed. In some embodiments, the computer system 1100 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the folding cache manager 113 of FIGS. 1-3). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 1100 includes a processing device 1102, a main memory 1104 (e.g., read-only memory (ROM), flash memory, dynamic random access memory (DRAM) such as synchronous DRAM (SDRAM) or RDRAM, etc.), a static memory 1106 (e.g., flash memory, static random access memory (SRAM), etc.), and a data storage system 1118, which communicate with each other via a bus 1130.

Processing device 1102 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 1102 can also be one or more special-purpose processing devices such as an application specific integrated circuit (ASIC), a field programmable gate array (FPGA), a digital signal processor (DSP), network processor, or the like. The processing device 1102 is configured to execute instructions 1126 for performing the operations and steps discussed herein. The computer system 1100 can further include a network interface device 1108 to communicate over the network 1120.

The data storage system 1118 can include a machine-readable storage medium 1124 (also known as a computer-readable medium) on which is stored one or more sets of instructions 1126 or software embodying any one or more of the methodologies or functions described herein. The instructions 1126 can also reside, completely or at least partially, within the main memory 1104 and/or within the processing device 1102 during execution thereof by the computer system 1100, the main memory 1104 and the processing device 1102 also constituting machine-readable storage media. The machine-readable storage medium 1124, data storage system 1118, and/or main memory 1104 can correspond to the memory sub-system 110 of FIG. 1.

In one embodiment, the instructions 1126 include instructions to implement functionality corresponding to a component (e.g., the folding cache manager 113 of FIGS. 1-3). While the machine-readable storage medium 1124 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A system comprising:
a volatile memory device;
a non-volatile memory device; and
a processing device, operatively coupled with the volatile memory device and the non-volatile memory device, to perform operations comprising:
retrieving data stored in a set of source management units on the non-volatile memory device;
storing the data in a set of cache management units on the volatile memory device in a predefined order of the set of cache management units; and
sending the data in the predefined order to a set of destination management units on the non-volatile memory device.

2. The system of claim 1, wherein the operations further comprise:
generating logical to physical (L2P) metadata associated with the data during the storing, the P2L metadata mapping one or more logical addresses of the data to one or more physical addresses corresponding to the set of destination management units on the non-volatile memory device; and
storing the P2L metadata in the set of cache management units on the non-volatile memory device.

3. The system of claim 2, wherein sending the data in the predefined order to the set of destination management units further comprises:
programming the data on the set of destination management units according to the one or more physical addresses in the P2L metadata.

4. The system of claim 1, wherein the set of source management units comprises a set of single level cell (SLC) page stripes, wherein the set of destination management units comprises a set of quad level cell (QLC) page stripes, and wherein the volatile memory device comprises a dynamic random access memory (DRAM) device.

5. The system of claim 1, wherein the set of source management units comprises a first set of quad level cell (QLC) page stripes, wherein the set of destination management units comprises a second set of quad level cell (QLC) page stripes, and wherein the volatile memory device comprises a dynamic random access memory (DRAM) device.

6. The system of claim 1, wherein sending the data in the predefined order to the set of destination management units further comprises:
performing a two pass programming operation to program the data on the set of destination management units, wherein the two pass programming operation comprises performing a first program pass to apply a first set of voltages and performing a second program pass to apply a second set of voltages; and
responsive to determining that the second program pass of the two pass programming operation is completed, releasing the set of cache management units.

7. The system of claim 1, wherein the operations further comprise:
storing the data in the set of cache management units until an amount of stored valid data satisfies a threshold criterion; and
sending the data to the set of destination management units responsive to determining that the amount of stored valid data satisfies the threshold criterion.

8. The system of claim 1, wherein the data is retrieved in a sequential order of valid data stored in the set of source management units, and wherein the predefined order of the set of cache management units is a sequential order of a dynamic random access memory (DRAM) stripe.

9. A method, comprising:
retrieving, by a processing device operatively coupled with a volatile memory device and a non-volatile memory device, data stored in a set of source management units on the non-volatile memory device;
storing the data in a set of cache management units on the volatile memory device in a predefined order of the set of cache management units; and
sending the data in the predefined order to a set of destination management units on the non-volatile memory device.

10. The method of claim 9, further comprising:
generating logical to physical (L2P) metadata associated with the data during the storing, the P2L metadata mapping one or more logical addresses of the data to one or more physical addresses corresponding to the set of destination management units on the non-volatile memory device; and
storing the P2L metadata in the set of cache management units on the non-volatile memory device.

11. The method of claim 10, wherein sending the data in the predefined order to the set of destination management units further comprises:
programming the data on the set of destination management units according to the one or more physical addresses in the P2L metadata.

12. The method of claim 9, wherein the set of source management units comprises a set of single level cell (SLC) page stripes, wherein the set of destination management units comprises a set of quad level cell (QLC) page stripes, and wherein the volatile memory device comprises a dynamic random access memory (DRAM) device.

13. The method of claim 9, wherein the set of source management units comprises a first set of quad level cell (QLC) page stripes, wherein the set of destination management units comprises a second set of quad level cell (QLC) page stripes, and wherein the volatile memory device comprises a dynamic random access memory (DRAM) device.

14. The method of claim 9, wherein sending the data in the predefined order to the set of destination management units further comprises:
performing a two pass programming operation to program the data on the set of destination management units, wherein the two pass programming operation comprises performing a first program pass to apply a first set of voltages and performing a second program pass to apply a second set of voltages; and
responsive to determining that the second program pass of the two pass programming operation is completed, releasing the set of cache management units.

15. The method of claim 9, further comprising:
storing the data in the set of cache management units until an amount of stored valid data satisfies a threshold criterion; and
sending the data to the set of destination management units responsive to determining that the amount of stored valid data satisfies the threshold criterion.

16. The method of claim 9, wherein the data is retrieved in a sequential order of valid data stored in the set of source management units, and wherein the predefined order of the set of cache management units is a sequential order of a dynamic random access memory (DRAM) stripe.

17. A non-transitory computer-readable storage medium comprising instructions that, when executed by a processing device, operatively coupled with a volatile memory device and a non-volatile memory device, cause the processing device to perform operations comprising:
retrieving data stored in a set of source management units on the non-volatile memory device;
storing the data in a set of cache management units on the volatile memory device in a predefined order of the set of cache management units; and
sending the data in the predefined order to a set of destination management units on the non-volatile memory device.

18. The non-transitory computer-readable storage medium of claim 17, wherein the operations further comprise:
generating logical to physical (L2P) metadata associated with the data during the storing, the P2L metadata mapping one or more logical addresses of the data to one or more physical addresses corresponding to the set of destination management units on the non-volatile memory device; and
storing the P2L metadata in the set of cache management units on the non-volatile memory device.

19. The non-transitory computer-readable storage medium of claim 17, wherein the set of source management units comprises a set of single level cell (SLC) page stripes, wherein the set of destination management units comprises a set of quad level cell (QLC) page stripes, and wherein the volatile memory device comprises a dynamic random access memory (DRAM) device.

20. The non-transitory computer-readable storage medium of claim 17, wherein the set of source management units comprises a first set of quad level cell (QLC) page stripes, wherein the set of destination management units comprises a second set of quad level cell (QLC) page stripes, and wherein the volatile memory device comprises a dynamic random access memory (DRAM) device.
